(19) United States
(12) Patent Application Publication
(10) Pub. No.: US 2025/0148920 A1
(43) Pub. Date: May 8, 2025

(54) COUPLED AUTONOMOUS PODS FOR SHARED MOBILITY

(71) Applicant: Ohio State Innovation Foundation, Columbus, OH (US)

(72) Inventors: Bilin Aksun Guvenc, Columbus, OH (US); Levent Guvenc, Columbus, OH (US)

(21) Appl. No.: 18/934,431

(22) Filed: Nov. 1, 2024

Related U.S. Application Data
(60) Provisional application No. 63/595,438, filed on Nov. 2, 2023.

(51) Int. Cl. G08G 1/00; B60W 60/00; G07C 5/00

(52) U.S. Cl. CPC G08G 1/22; B60W 60/001; G07C 5/008; B60W 2554/4041; B60W 2554/4042; B60W 2554/802; B60W 2554/804; B60W 2556/45

(57) ABSTRACT

A system may include a plurality of autonomous vehicles (AVs) in electronic communication with one another that are each configured to electronically and/or mechanically connect and disconnect to one another to form variable AV trains. The example system can include a controller operatively coupled to the plurality of AVs that is configured to synchronize and/or docking operations, undocking operations and/or navigation of the plurality of AVs.

### CROSS-REFERENCE TO RELATED APPLICATIONS

This Application claims priority to and the benefit of U.S. Provisional Patent Application No. 63/595,438, titled “Coupled Autonomous Pods for Shared Mobility”, filed on Nov. 2, 2024, the content of which is hereby incorporated by reference in its entirety.

### BACKGROUND

Fixed route circulator type bus services are prohibitively expensive for small cities and some urban locations including smaller areas within larger cities. This is due to mobility demand being scattered in the periphery of the city, for example, in more affordable housing locations, while the popular destinations are more centralized. This results in mostly empty buses if mobility of the residents is the goal and not enough bus service if low-cost public transit is the goal. End mile (autonomous) shuttles are sometimes offered as a solution so that the fixed route circulator type bus service can operate on restricted routes with more passengers while the shuttles transfer passengers to the main bus line. This is still not very effective as bus service is reduced when overall demand is low to lower total cost.

It is with respect to these and other considerations that the various aspects and embodiments of the present disclosure are presented.

### SUMMARY

Embodiments of the present disclosure provide vehicles (e.g., autonomous vehicles (AVs), buses, pods) that can be electronically and/or mechanically coupled to one another to form variable size vehicles (e.g., AV trains, connected and/or modular vehicles). An example connected vehicle train may be small at peripheral locations (e.g., end mile locations) and can grow in size with more mobility demand (e.g., more passengers) as the vehicle/bus approaches central and popular destinations. In some implementations, a variable size vehicle/bus can be formed by combining small pods that can carry 2-4 passengers each. The pods will be an ideal solution for the end mile (also called first/last mile) problem and will be autonomous.

In some implementations, an autonomous vehicle system is provided. The system includes: a plurality of autonomous vehicles (AVs) (e.g., pods) in electronic communication with one another that are each configured to electronically and/or mechanically connect and disconnect to one another to form variable AV trains (e.g., configurations of merged AVs); and a controller operatively coupled to the plurality of AVs that is configured to synchronize and/or docking operations, undocking operations and/or navigation of the plurality of AVs. In some implementations, each variable AV train configuration has a different capacity. Each of the plurality of AVs can be modular. In some implementations, the controller is further configured to: synchronize and coordinate docking and undocking (e.g., electrical and/or mechanical connection and disconnection) and/or navigation using an optimization operation (e.g., one or more algorithms). The optimization operation can include perception and object detection algorithms. The optimization operation can be used to process ride hailing requests, dispatch AVs, and/or determine a route for each of the plurality of AVs. The optimization operation can minimize travel time and/or maximize a number of passengers served. In some implementations, each variable AV train is configured to respond to the external environment (e.g., traffic, traffic lights or signs, and the like) as a single unit.

In some implementations, a system is provided. The system can include: a plurality of autonomous vehicles (AVs) in electronic communication with one another that are each configured to electronically and/or mechanically connect and disconnect to one another to form various configurations of AV trains. Each of the plurality of AVs can include an edge computing device. Each of the plurality of AVs can be configured to communicate via a short-range wireless communication protocol (Near-Field Communication (NFC)). Each of the plurality of AVs can be configured to communicate via an over-the-air connection through one or more central servers using cellular internet connectivity. Each of the plurality of AVs can include a plurality of sensors (e.g., perception sensor, image sensor). Each of the plurality of AVs can be configured to: determine, via the plurality of sensors and/or received information, localization information of at least one other AV within a predetermined range; and self-navigate and/or synchronize with the at least one other AV based at least in part on the localization information. The localization information can include at least one of a location, relative distance, speed, or acceleration.

In some implementations, a computer-implemented method is provided. The computer-implemented method can include: receiving, by at least one processor, at least one ride hailing request; determining, by the at least one processor, one or more optimal docking location(s) based at least in part on the at least one ride hailing request; determining, by the at least one processor, at least one AV route to the one or more optimal docking location(s); and triggering, by the at least one processor, docking operations, undocking operations, and/or navigation of at least one AV train based at least in part on the at least one AV route. The docking operations, undocking operations, and/or navigation can be performed in a manner that balances mobility demand requests, dispatches AVs, and arranges their docking and undocking to minimize travel time and wait time.

In some implementations, an autonomous vehicle system is provided. The system can include: a plurality of autonomous vehicles (AVs) in electronic communication with one another, each AV including: at least one sensing device; at least one processor; and a memory having instructions stored thereon, wherein the instructions when executed by the at least one processor, cause the at least one processor to: obtain vehicle data and/or environmental data via the at least one sensing device; determine one or more following or coupling parameters for forming a variable AV train; electronically and/or mechanically connect and disconnect to at least another AV to form the variable AV train; and continuously broadcast the obtained vehicle and/or environmental data to the at least another AV subsequent to forming the variable AV train.

In some implementations, each of the plurality of AVs is configured to obtain the vehicle data and/or environmental data or form the variable AV train in response to a request or command received from a computing device or at least one mobile device.

In some implementations, the instructions when executed by each processor cause each processor to further: self-navigate using the one or more following parameters and/or the broadcast and/or received data.

In some implementations, operations of each AV are optimized using one or more algorithms or machine learning models.

In some implementations, each processor is further configured to dynamically switch between obtaining data from the at least one sensing device to at least one mobile device within the AV based on detected environmental conditions.

In some implementations, the environmental conditions include at least one of poor visibility, sensor malfunction, and low battery.

In some implementations, each processor is configured to continuously broadcast the obtained vehicle and/or environmental data using a Bluetooth BLE advertising mode, short-range wireless communication protocol, or Near-Field Communication (NFC) protocol.

In some implementations, the vehicle data and/or environmental data includes at least one of speed, location, acceleration, relative distance, or relative speed.

In some implementations, each AV is configured to self-navigate using a reinforcement learning model or optimization operation.

In some implementations, each AV comprises a drive-by-wire component.

In some implementations, the techniques described herein relate to an autonomous vehicle (AV) including: at least one sensing device; at least one processor (e.g., cloud-based processing system) in electronic communication with the at least one vehicle; and a memory having instructions thereon, wherein the instructions when executed by the processor, cause the processor to: obtain vehicle data and/or environmental data via the at least one sensing device; determine one or more following or coupling parameters for forming a variable AV train; electronically and/or mechanically connect and disconnect to at least another AV to form the variable AV train; and continuously broadcast the obtained vehicle and/or environmental data to the at least another AV subsequent to forming the variable AV train.

In some implementations, the AV is configured to obtain the vehicle data and/or environmental data or form the variable AV train in response to a request or command received from a computing device or at least one mobile device.

In some implementations, the instructions when executed by the processor causes the processor to further: self-navigate using the one or more following parameters and/or the broadcast and/or received data.

In some implementations, operations of the AV are optimized using one or more algorithms or machine learning models.

In some implementations, the processor is further configured to dynamically switch between obtaining data from the at least one sensing device to at least one mobile device within the AV based on detected environmental conditions.

In some implementations, the environmental conditions include at least one of poor visibility, sensor malfunction, and low battery.

In some implementations, the processor is configured to continuously broadcast the obtained vehicle and/or environmental data using a Bluetooth BLE advertising mode, short-range wireless communication protocol, or Near-Field Communication (NFC) protocol.

In some implementations, the vehicle data and/or environmental data includes at least one of speed, location, acceleration, relative distance, or relative speed.

In some implementations, a computer-implemented method is provided. The method can include: receiving, by at least one processor, at least one ride hailing request; determining, by the at least one processor, one or more optimal docking location(s) based at least in part on the at least one ride hailing request; determining, by the at least one processor, at least one AV route to the one or more optimal docking location(s); and triggering, by the at least one processor, docking operations, undocking operations, and/or navigation of at least one variable AV train based at least in part on the at least one AV route, wherein the at least one variable AV train includes a plurality of A Vs that are each configured to: determine one or more following or coupling parameters for forming the at least one variable AV train, electronically and/or mechanically connect and disconnect to at least another AV to form the at least one variable AV train, and continuously broadcast obtained vehicle and/or environmental data to at least another AV subsequent to forming the at least one variable AV train.

In some implementations, each AV is configured to dynamically switch between obtaining data from at least one sensing device and at least one mobile device within the AV based on detected environmental conditions.

Further features of embodiments of the present disclosure will become apparent to those skilled in the art upon reviewing the following detailed description.

### BRIEF DESCRIPTION OF THE DRAWINGS

The accompanying drawings, which are incorporated in and constitute a part of this specification, illustrate embodiments and together with the description, serve to explain the principles of the devices and methods.

FIG. 1 depicts an example system in accordance with an illustrative embodiment.

FIG. 2A and FIG. 2B are flowchart diagrams depicting example methods in accordance with illustrative embodiments.

FIG. 3 shows an autonomous driving system that can be used to test and/or train AVs prior to deployment in accordance with illustrative embodiments.

FIG. 4 is an example computing device in accordance with an illustrative embodiment.

### DETAILED DESCRIPTION

This description provides examples not intended to limit the scope of the appended claims. The figures generally indicate the features of the examples, where it is understood and appreciated that like reference numerals are used to refer to like elements. Reference in the specification to “one embodiment” or “an embodiment” or “an example embodiment” means that a particular feature, structure, or characteristic described is included in at least one embodiment described herein and does not imply that the feature, structure, or characteristic is present in all embodiments described herein.

Embodiments of the present disclosure relate to development and use of a holistic virtual environment consisting of a realistic map, realistic 3D environment modeling in a Game Engine visualization, realistic vehicle dynamics, realistic autonomous vehicle sensor data, realistic emulation of autonomous driving algorithms and realistic traffic-in-the-loop all running simultaneously. This holistic virtual environment is used with a demand model for autonomous mobility (robo-taxi) service and used to evaluate different robo-taxi supply possibilities to determine the optimal deployment scheme for robo-taxis. The robo-taxis can use a ride hailing application (App) and can also use ride sharing. The same approach can also be used to test food and supply delivery applications of the robo-taxis (or smaller autonomous delivery vehicles) including operation during a pandemic.

Embodiments of the present disclosure provide methods and a holistic environment that are used to verify safe and reliable operation of autonomous vehicles by introducing unexpected situations (e.g., sudden collision risk with car, vulnerable road user, unexpected emergency stop, unexpected deviation from path, misaligned objects, and the like) and disturbances (e.g., weather effects, sensor malfunctions, and the like). This approach can also be used to test the deep billboard problem and in conjunction with sensor falsification. This method and approach can be used in Model-in-the-Loop (MIL) and Hardware-in-the-Loop (HIL) simulation and later with Vehicle in Virtual Environment (VVE) technologies.

In some implementations, the technology is based on small autonomous pods that are electric, and hence green, and configured to house 2 or 4 passengers. These autonomous pods can be used for ride sharing especially in urban arterial roads to move passengers to public transportation (e.g., buses, metro, train, and the like) or in outdoor shopping areas, large campuses such as universities or factories, or stadiums (e.g., for moving passengers to remote parking lots).

In some embodiments, the pods may have the ability to be either mechanically coupled or electronically coupled (e.g., close proximity platooning). In the case of mechanical coupling, the electric drive systems of the pods can work in coordination such that the overall driving load will be taken care of by all of them and not the lead vehicle taking all the load. Same will be true of coordinated steering of the mechanically coupled pods. The technology also includes the algorithm to determine the optimal number of coupled pods and how they will break up into smaller trains or merge together again to meet the current ride hailing and ride sharing demand. In some embodiments, the pods can be ride-hailed (on-demand) and will pick passengers from peripheral locations with scattered demand and move them to main roads. In some embodiments, the pods can either link together mechanically and/or be coupled electronically (cooperative driving) to make virtual larger vehicles thereby emulating the larger bus service on main roads. As the routes move from main roads to peripheral locations, the pods will disengage and move the smaller number of passengers back to their peripheral locations (e.g., housing). The entire system is on-demand (ride-hailed) such that an optimization algorithm balances mobility demand requests and dispatches the pods and arranges their docking and undocking to minimize travel time and wait time.

### Example System

In various embodiments, AVs (e.g., pods) are configured to electronically, electrically, and/or mechanically connect and disconnect with one another to form different configurations of variable (e.g., merged, connected) vehicles (e.g., trains, buses, and/or the like) in order to address the end or first/last mile problem.

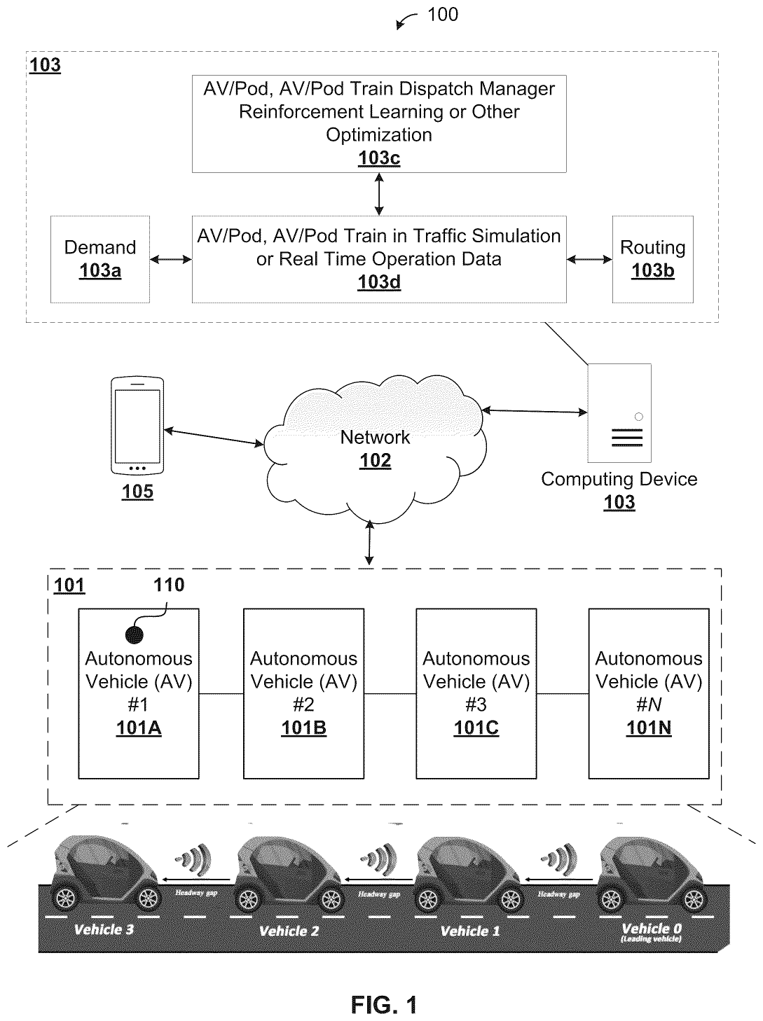

FIG. 1 is a schematic diagram depicting an example system 100 in accordance with an illustrative embodiment. As shown, the example system 100 comprises a plurality of AVs 101. Specifically, the plurality of AVs 101 includes a first AV 101A, a second AV 101B, a third AV 101C . . . an n-th AV 101N. Each of the plurality of AVs 101 can be a semi-autonomous, motorized and/or electric vehicle, modular vehicle, pod, car, trolley, shuttle, train car, motorcycle, combinations thereof, and/or the like. In some embodiments, each of the plurality of AVs 101A-N comprises drive-by-wire (DbW) technology and can include one or more DbW components that employ electronic systems to control vehicle functions instead of physical/mechanical connections.

Each of the plurality of AVs 101A-N can comprise one or more sensing devices (e.g., sensing device 110), also referred to herein as a sensor box or sensor, configured to monitor and/or obtain real-time information/data from the environment (e.g., image data, video data, audio data, vehicle data, environmental data (e.g., temperature, pressure) and the like). The sensing device(s) 110 can be or comprise one or more optical devices, advanced cameras, infrared cameras, light detection and ranging (LiDAR) sensor(s), short range radio detection and ranging (RADAR) sensor(s), Inertial Measurement Units (IMUs), Global Positioning System (GPS) sensors, or combinations thereof. The AVs 101A-N can operate using pattern-based learning, reinforcement learning, optimization operations, and by processing data obtained via the sensing device(s) 110 and other sources to support autonomous decision making.

As further illustrated, the plurality of AVs 101 is in electronic communication with at least one computing device 103 and/or one or more mobile devices 105 over a network 102. The network 102 can include a wired or wireless local area network (LAN), personal area network (PAN), metropolitan area network (MAN), wide area network (WAN), or the like, as well as any hardware, software and/or firmware required to implement it (such as, e.g., network routers, and/or the like). Additionally, each of the plurality of AVs 101 is in electronic communication with one another to facilitate sharing data, cooperative steering, and other operations, for example, via a short-range wireless communication protocol such as, but not limited to, Near-Field Communication (NFC), Bluetooth BLE advertising protocol, or the like. Each AV 101 can be configured to continuously broadcast obtained vehicle and/or environmental data to one or more other AVs to facilitate cooperative driving and other operations. Each AV 101 can self-navigate or independently navigate an environment based on one or more determined or provided following or coupling parameters (e.g., determined based, at least in part, on broadcast data obtained via its own sensing device 110 or from other AVs within the network). The plurality of AVs 101A-N can define a mesh network and/or each comprise an edge computing device. In some examples, each variable AV train (composed of two or more AVs) is configured to respond to the external environment (e.g., traffic, traffic lights or signs, and the like) as a single unit.

In some implementations, the at least one computing device 103 is configured to receive data (e.g., from the plurality of AVs 101), process the data to generate outputs (e.g., optimal docking location(s)) that can be used to synchronize and/coordinate operations (e.g., movement, navigation, transmission of destination information, docking or undocking operations) of the plurality of AVs 101. In some examples, the at least one computing device 103 is configured to coordinate formation of variable AV trains of different configurations (e.g., with different capacities). The example computing device 103 can utilize one or more models and/or algorithms for dispatching AVs/pods to target end mile locations, regrouping them, forming pod trains on main roads followed by separating them into smaller pod trains or individual pods for end mile destinations. In some implementations, the computing device 103 (or in some examples, each AV 101) coordinates AV operations using reinforcement learning (RL) to minimize passenger wait time and to maximize the number of passengers served. The computing device 103 can generate a model of a traffic network and calibrate it based on historical traffic data and/other inputs. In some implementations, AVs can be deployed in a manner that optimizes the use of AV fleets.

In some implementations, the computing device 103 employs RL to implement an AV dispatch service that can account for a network, AVs/AV agents, traffic, and requests (e.g., ride sharing and/or transportation requests). The network can be calibrated based on vehicle capacity, route choice, and system performance. An example network can be adapted with designated docking and undocking locations distributed along the network. As depicted in FIG. 1, the computing device 103 can include a demand component 103a configured to process requests placed by passengers, a routing component 103b configured to determine travel routes for the AVs, and a management component 103c which directs dispatchment of the AVs based on execution of one or more algorithms. The computing device 103 can comprise a simulation component 103d that can be used to train the system to generate various outputs. The computing device 103 can be tuned with parameters such as maximum wait time for pick-up and maximum wait time for drop-off. At each time step, the computing device 103 receives requests and uses such requests to update each component 103a, 103b, 103c, 103d. The computing device 103 can use a validation model, for example, a parameterized Wiedemann' 99 model, a stimulus-response model, a Gazis-Herman-Rothery (GHR) model to coordinate the formation of variable AV trains or model these operations in a training environment (e.g., in an off-line mode). Model parameters can include a minimum distance between two AVs, a maximum velocity of an AV, acceleration smoothness, vehicle reaction time, acceleration and deceleration values, and a target distance between two AVs.

In some examples, the computing device 103 coordinates such operations by matching the demand from multiple users obtained through a ride hailing application that is accessible via one or more mobile devices 105. The algorithm can place rewards on the highest number of people served in the least amount of time and places costs on wait times and not having enough passengers in individual pods. In one implementation, the algorithm uses a neural network that is first trained on a simulator with realistic microscopic traffic and learns to maximize rewards and minimize cost. The learning is further improved during actual operation to improve rewards while minimizing cost and obeying constraints. Additional examples of algorithms that can be used to execute some of the methods described herein are described in Meneses-Cime, K.; Aksun-Guvenc, B.; Guvenc, L. Optimization of On-Demand Shared Autonomous Vehicle Deployments Utilizing Reinforcement Learning. Sensors 2022, 22, 8317. https://doi.org/10.3390/s22218317, the content of which is incorporated by reference herein in its entirety.

As further depicted, the system 100 includes one or more mobile devices 105 in communication with the computing device 103 and/or plurality of AVs 101A-N over the network 102. In some implementations, the AVs 101A-N can use data obtained via the mobile device 105 to determine information, including but not limited to, acceleration, speed, and position information and can broadcast such information to other AVs/pods and/or computing devices (e.g., computing device 103) at a constant rate. In some examples, the mobile device 105 can be docked in a stationary position within the AV and an application executing thereon can be used to collect vehicle information (e.g., acceleration, speed, and position), for instance, using the mobile device's 105 built in accelerometer and/or GPS data. In some implementations, localization information from the mobile device 105 (e.g., including triangulation with respect to mobile communication towers in addition to GPS information) is obtained and used. In some implementations, each of the plurality of AVs 101A-N broadcasts its self-obtained motion data information, for example, using Bluetooth 5.x in advertising mode, or cellular communication, over-the-cloud communication, or other wireless communication. Such communication is time stamped and can be input into an algorithm for inter-AV communication and/or electronic coupling to enable a second AV 101B to follow a first AV 101A while maintaining a target time gap or distance therebetween. In certain examples, the mobile device 105 records various measurement (e.g., acceleration, speed, position) and transmits this information to nearby in-vehicle mobile devices, for example, using Bluetooth BLE advertising mode.

This disclosure contemplates that an example AV can be configured to dynamically switch between obtaining data and/or transmitting data from a sensing device 110 and a mobile device 105 based on environmental or other conditions. For example, the example AV can switch from obtaining data via the sensing device 110 to obtaining data via the mobile device 105 in response to detecting a sensor malfunction associated with the sensing device 110 or in order to conserve energy (e.g., in response to detecting that the AV battery is low or falls below a predetermined threshold). Similarly, the example AV can switch from obtaining data via the mobile device 105 to the sensing device 110 in response to detecting that cellular coverage within an environment is poor or that one or more mobile device 105 sensors are malfunctioning.

By way of example, in an AV train comprising a first AV 101A and a second AV 101B, the second AV 101B can use data obtained via its on-board sensing device 110 and/or the mobile device 105 to determine necessary commands to be sent (e.g., communicated, transmitted) to its AV drive-by-wire controls to maintain a desired or target time gap between the first AV 101A and the second AV 101B when they are electronically coupled to one another. In some implementations, a front looking camera or camera/radar combination of the sensing device 110 and/or mobile device 105 is used to improve or enhance detection/tracking of the vehicle in front in case of temporary problems in communication. Additional examples of motion information based car following techniques using a dedicated short range communication (DSRC) modem and vehicle motion information is described in L. Guvenc, . . . , B. Aksun-Guvenc et al., “Cooperative Adaptive Cruise Control Implementation of Team Mekar at the Grand Cooperative Driving Challenge,” in IEEE Transactions on Intelligent Transportation Systems, vol. 13, no. 3, pp. 1062-1074 Sept. 2012, doi: 10.1109/TITS.2012.2204053), the content of which is hereby incorporated by reference herein in its entirety. Additional examples of using a smartphone App for communication and data collection is described in Gelbal, S. Y.; Aksun-Guvenc, B.; Guvenc, L. Vulnerable Road User Safety Using Mobile Phones with Vehicle-to-VRU Communication. Electronics 2024, 13, 331. https://doi.org/10.3390/electronics13020331, the content of which is hereby incorporated by reference herein in its entirety.

### Example Methods

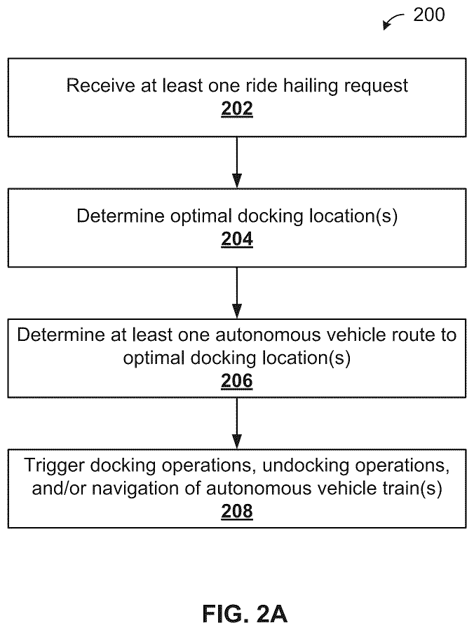

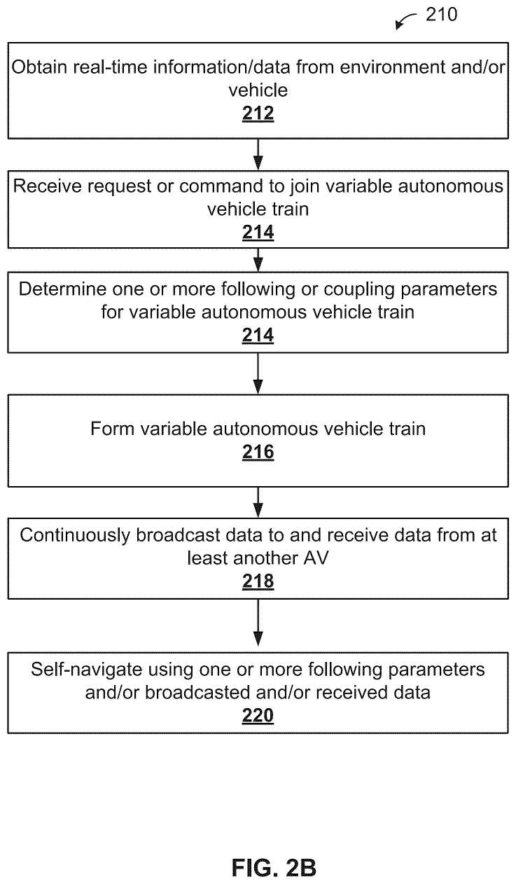

Referring now to FIG. 2A, a flowchart diagram depicting an example method 200 in accordance with certain embodiments of the present disclosure is provided. The method 200 can be performed by a computing device, controller, or the like (e.g., computing device 103 described above in connection with FIG. 1). In some implementations, the method 200 can be entirely or partially performed by one or more of the plurality of AVs 101.

At step/operation 202, the computing device receives at least one ride hailing request. For example, ride hailing requests are processed and pods are dispatched to demand locations.

At step/operation 204, the computing device determines at least one optimal docking location corresponding with the at least one ride hailing request. For example, the computing device can match destination requests from different demand locations.

At step/operation 206, the computing device determines (e.g., identifies) at least one AV route to the optimal docking location. For example, the computing device can use an algorithm to determine individual pod routes so that they meet at optimal locations to dock with other pods with similar destinations.

At step/operation 208, the computing device triggers (e.g., coordinates, causes, and/or provides at least one control signal) docking operations, undocking operations, and/or navigation of AV train(s). For example, the computing device may provide a control signal to cause two or more AVs (e.g., pods, cars) to electronically and/or mechanically connect to one another or disconnect from one another based on the at least one AV route and/or other outputs and parameters determined by the computing device. Each AV/pod can include a quick mechanical dock/undock mechanism. Pods can get close to each other and communicate with each other to form a pod “train” (virtual bus) electronically. This may be similar to towing a trailer where many pods connect like a “train” (virtual bus) and drive cooperatively. The AVs/pods can communicate with each other and share the longitudinal driving load that is necessary as well as coordinate steering. Optimality is for minimizing travel time and maximizing number of passengers served. In some examples, on main roads where there are more passengers, there are more pods that dock together.

Subsequently, in some implementations, the computing device can coordinate movement of passengers from destinations back to their starting locations. For example, at the optimal locations, the pod “train” starts undocking, as needed, with individual or smaller sized pod “trains” moving towards locations of less passenger return.

In some implementations, AVs/pods use relative motion (distance, speed, acceleration) and localization information to keep a small but safe time gap between them. Relative motion and localization info may use forward looking perception sensors, image sensors (e.g., cameras), and/or communicated motion information. In some implementations, AVs/pods handle traffic lights, stop signs, and the like as a single unit. The localization information can comprise location, relative distance, speed, and/or acceleration.

FIG. 2B is flowchart diagram depicting another example method 210 in accordance with certain embodiments of the present disclosure. The method 210 can be entirely or partially performed by a computing device, controller, or the like (e.g., each of the plurality of AVs 101A-N described above in connection with FIG. 1).

At step/operation 212, the AV obtains real-time information/data from the environment and/or vehicle. As noted above, the AV can obtain such data via a sensing device 110 or mobile device 105 and may dynamically switch between the two data sources based on environmental conditions (e.g., low battery mode, poor camera visibility, sensor malfunction, or the like).

At step/operation 214, the AV receives a request to join an AV train. In some implementations, the AV receives the request from a computing device (103) configured to coordinate AV train formation and navigation. Alternatively, the AV can receive the request from a mobile device 105 (via an App operated by a user of the mobile device 105 that is traveling within the AV). In other examples, AV can independently decide to join an AV train based on one or more shared goals or directives set for all AVs in a network that are in communication with one another and configured to facilitate transportation within a location.

At step/operation 214, the AV determines one or more following and/or coupling parameters for joining an AV train. As noted above, each AV/pod can be coupled to another AV/pod mechanically and/or electronically/electrically. In examples where AVs are connected electronically/electrically only, each AV/pod can determine one or more following parameters to ensure that it is safely traveling adjacent one or more other pods (e.g., target speed, target distance, or the like).

At step/operation 216, the AV forms the AV train based, at least in part, on the determine following and/or coupling parameters. Each AV may use on-board DbW technology to electronically connect with another AV.

At step/operation 218, subsequent to being mechanically and/or electrically coupled to one or more other AVs, the AV continuously broadcasts its motion data (e.g., position information, speed, acceleration) to other AVs in the AV train to facilitate coordinated navigation of the AVs based on real-time environmental and vehicle data.

At step/operation 220, the AV self-navigates as part of the variable AV train using the one or more determined following parameters, the broadcast data (e.g., self-reported or obtained) and/or received data from the one or more other AVs or computing device.

### Example Autonomous Vehicle System

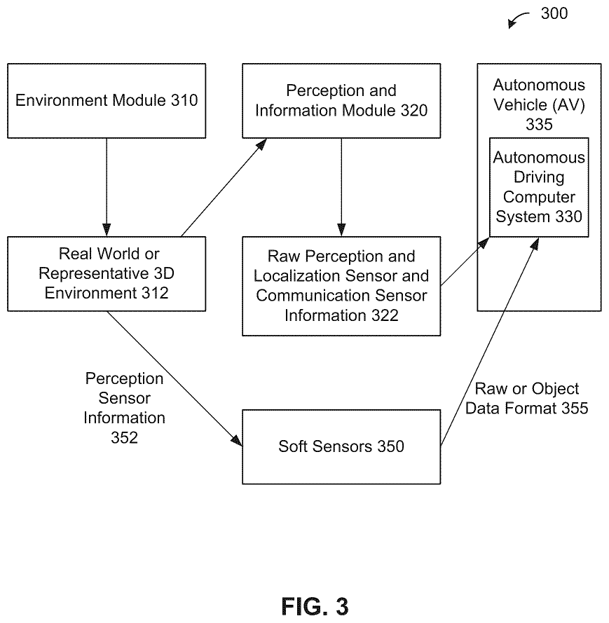

FIG. 3 shows an autonomous driving system 300 in accordance with an illustrative embodiment. The system 300 can be used to test and/or train AVs prior to deployment.

The system 300 comprises an environment module 310 that is configured to obtain data/information from the AV's environment. The system 300 also comprises a perception and information module 320 that is configured to generate raw perception and localization sensor and communication sensor information 322 from the AV's environment or representative 3D environment 312. The system 300 also comprises an autonomous driving computer system 330 in an AV 335. In some implementations, the autonomous driving computer system 330 receives the raw perception and localization sensor and communication sensor information 322 such that the autonomous driving system behaves as if the AV 335 is in a realistic real world or representative 3D environment.

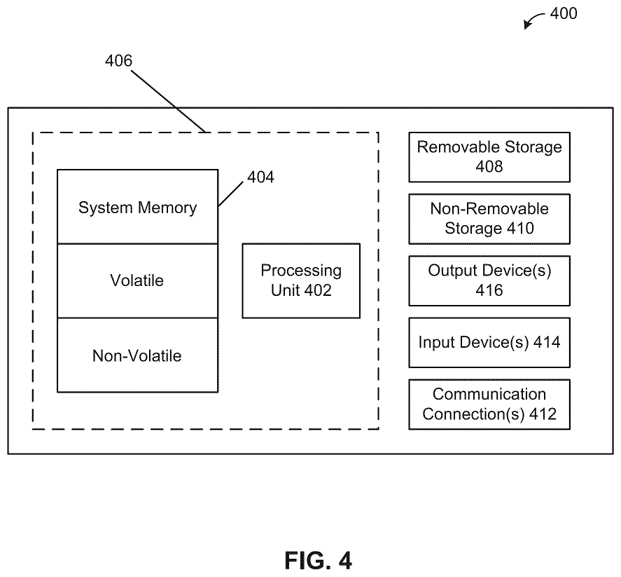

The autonomous driving computer system 330 may be implemented using a variety of computing devices such as desktop computers, laptop computers, tablets, etc. Other types of computing devices may be supported. A suitable computing device is illustrated in FIG. 4 as the computing device 400.

In an implementation, the system 300 is configured to run in real time and keep track of actual motion of the AV 335 with respect to a starting position and place a corresponding soft vehicle model in a correct relative position and pose in the real world or representative 3D environment 312.

In an implementation, the system 300 further comprises a plurality of soft sensors 350 configured to obtain perception sensor information 352 from the AV's environment/real world or representative 3D environment 312, convert the perception sensor information 352 to at least one raw or object data format 355 expected by an autonomous driving computer system 330 of the AV 335, and send the converted perception sensor information to the autonomous driving computer system 330, bypassing physical sensor connections in the AV 335.

The computational system runs in real time and keeps track of the actual motion of the vehicle with respect to the starting (home) position which it uses to place the corresponding soft vehicle model in the correct relative position and pose in the virtual 3D environment. Soft sensors (sensor models) are used to get perception sensor information (e.g., RGB camera, depth camera, 3D LIDAR, RADAR, communication sensor including DSRC, C-V2X, Bluetooth, 5G, 6G, smartphone, etc.) from the 3D environment, convert them to raw or object data format(s) expected by the AV's autonomous driving computer and physically send them to that computer, bypassing the physical sensor connections in the AV. In this manner, the AV is immersed in a virtual reality setting.

VVE testing/evaluation is executed in a large, flat, and empty area (like a large parking lot or testpad area), in some implementations. The starting point of the VVE testing is marked as the home position. Large virtual environments that do not fit the physical test area are broken down into parts that fit. These parts are then connected using extraneous bends/turns to turn the vehicle around as it reaches the physical area limits while switching from one virtual environment part to the other. Large virtual environments can easily be tested using this method.

In some implementations, AV sensor data is extracted from these environments and sent to an AV computer where AV driving functions reside. An in-vehicle product comprises a high-performance GPU/CPU in-vehicle computer that runs the virtual environment simulation in real time and sends AV sensor data to the AV driving computer while the vehicle is operating inside the large empty test area. A connection box may be used to ease the connection of the simulated sensor data signals to the tested vehicle's autonomous driving system while bypassing the actual sensor connections when used as a development system. In this manner, the developer can switch easily from VVE testing to actual road testing and vice versa. Extended reality (XR), augmented reality (AR), or virtual reality (VR) goggles may be used in some implementations, especially for demonstration applications, along with software mapping of the virtual world into various test area dimensions.

### Machine Learning

This disclosure contemplates that various machine learning models and algorithms can be used (e.g., by the computing device 103, mobile device 105, or AV 101 described in FIG. 1) to implement any of the methods and systems described herein. In some implementations, reinforcement learning is used by each AV to make its own decisions while interacting with other AVs within the network and/or navigating its environment.

The exemplary system can be implemented using one or more artificial intelligence and machine learning operations. The term “artificial intelligence” can include any technique that enables one or more computing devices or comping systems (i.e., a machine) to mimic human intelligence. Artificial intelligence (AI) includes but is not limited to knowledge bases, machine learning, representation learning, and deep learning. The term “machine learning” is defined herein to be a subset of AI that enables a machine to acquire knowledge by extracting patterns from raw data. Machine learning techniques include, but are not limited to, logistic regression, support vector machines (SVMs), decision trees, Naïve Bayes classifiers, and artificial neural networks. The term “representation learning” is defined herein to be a subset of machine learning that enables a machine to automatically discover representations needed for feature detection, prediction, or classification from raw data. Representation learning techniques include, but are not limited to, autoencoders and embeddings. The term “deep learning” is defined herein to be a subset of machine learning that enables a machine to automatically discover representations needed for feature detection, prediction, classification, etc., using layers of processing. Deep learning techniques include but are not limited to artificial neural networks or multilayer perceptron (MLP). Reinforcement learning can also use deep neural networks, hence becoming Deep Reinforcement Learning (DRL).

Machine learning models include supervised, semi-supervised, and unsupervised learning models. In a supervised learning model, the model learns a function that maps an input (also known as feature or features) to an output (also known as target) during training with a labeled data set (or dataset). In an unsupervised learning model, the algorithm discovers patterns among data. In a semi-supervised model, the model learns a function that maps an input (also known as feature or features) to an output (also known as a target) during training with both labeled and unlabeled data.

Reinforcement Learning (RL). RL is a machine learning technique where an agent (e.g., AV) learns to make decisions by aiming to maximize a cumulative reward value over time. RL employs a feedback loop of rewards and penalties through which the agent is able to refine its behavior over time as it navigates an environment. In RL: Action (A) represents the choices available to a given agent at a time step, state(S) refers to a representation of the environment, reward (R) refers to feedback received by the agent after an action that enables it to determine whether such action was favorable or unfavorable (penalties are negative rewards), policy (π) refers to the strategy implementd by an agent to determine which actions to take based on current state(S), and value function is a predictive function used to predict future rewards of actions and/or states that is used by the agent to direct them to long-term benefits. Example RL techniques include policy gradient methods, Q-learning methods, and Deep Q-Networks (DQN).

Neural Networks. An artificial neural network (ANN) is a computing system including a plurality of interconnected neurons (e.g., also referred to as “nodes”). This disclosure contemplates that the nodes can be implemented using a computing device (e.g., a processing unit and memory as described herein). The nodes can be arranged in a plurality of layers such as input layer, an output layer, and optionally one or more hidden layers with different activation functions. An ANN having hidden layers can be referred to as a deep neural network or multilayer perceptron (MLP). Each node is connected to one or more other nodes in the ANN. For example, each layer is made of a plurality of nodes, where each node is connected to all nodes in the previous layer. The nodes in a given layer are not interconnected with one another, i.e., the nodes in a given layer function independently of one another. As used herein, nodes in the input layer receive data from outside of the ANN, nodes in the hidden layer(s) modify the data between the input and output layers, and nodes in the output layer provide the results. Each node is configured to receive an input, implement an activation function (e.g., binary step, linear, sigmoid, tanh, or rectified linear unit (ReLU) function), and provide an output in accordance with the activation function. Additionally, each node is associated with a respective weight. ANNs are trained with a dataset to maximize or minimize an objective function. In some implementations, the objective function is a cost function, which is a measure of the ANN's performance (e.g., error such as L1 or L2 loss) during training, and the training algorithm tunes the node weights and/or bias to minimize the cost function. This disclosure contemplates that any algorithm that finds the maximum or minimum of the objective function can be used for training the ANN. Training algorithms for ANNs include but are not limited to backpropagation. It should be understood that an artificial neural network is provided only as an example machine learning model. This disclosure contemplates that the machine learning model can be any supervised learning model, semi-supervised learning model, or unsupervised learning model. Optionally, the machine learning model is a deep learning model. Machine learning models are known in the art and are therefore not described in further detail herein.

A convolutional neural network (CNN) is a type of deep neural network that has been applied, for example, to image analysis applications. Unlike traditional neural networks, each layer in a CNN has a plurality of nodes arranged in three dimensions (width, height, depth). CNNs can include different types of layers, e.g., convolutional, pooling, and fully-connected (also referred to herein as “dense”) layers. A convolutional layer includes a set of filters and performs the bulk of the computations. A pooling layer is optionally inserted between convolutional layers to reduce the computational power and/or control overfitting (e.g., by down-sampling). A fully-connected layer includes neurons, where each neuron is connected to all of the neurons in the previous layer. The layers are stacked similar to traditional neural networks. GCNNs are CNNs that have been adapted to work on structured datasets such as graphs.

### Example Optimization Method

An approach to optimizing the AV or AV/pod train dispatcher (e.g., computing device 103 or AV 101) can be gamifying it. The problem is first set-up as a Markov decision process (MDP). First, assume there is a fleet of m AVs ready for deployment. The traffic network of deployment in question can be modeled as a directed connected graph N=(V, E) and n pick-up/drop-off stops can be chosen for a mobility application. These are enumerated B={b₁, . . . , bₙ} and can be located by placing it at a distance d from the source node.

Next, throughout the hours of operation, the AV or AV/pod train travels between pick-up areas (bₙ) attending to the requests of passengers. The state of an AV/pod, s, is then representative of the base in which it is in. Furthermore, to provide the dispatcher with more information, the state, s, is augmented with the state of the requests at pick-up/drop off areas. The pick-up-areas are enumerated i∈[m] and an encoding representation is utilized where for vector \vec{θ} each entry θᵢ is 1 if there is at least one request coming from base bᵢ and 0 otherwise.

Nₚ is the number of passengers in vehicle i and Pₘₐₓ is the maximum number of seats in the vehicle. The state of the vehicle at time t is represented by sₜ=(bᵢ, \vec{θ}, Nₚ).

When the vehicle is driving. the driving behavior is set to bᵢ=−1. The dispatching process is modeled as a Markov and decision process. The next dispatching request attended to depends only on the previous request attended to and is expressed mathematically in terms of the given probability state transition P as P(Sₜ|Sₜ₋₁, . . . , s₀)=P(Sₜ|Sₜ₋₁) being the same at every point in time.

A Markovian decision problem requires an augmentation of a Markovian process with a set of actions and rewards functions. In the case of the dispatch problem, the set of actions is an array containing all the possible routes from the current pick-up spot. The shortest path with respect to distance is found by creating a directed graph representation of the traffic network, where nodes equal intersections and edges equal roads. Then, Dijkstra's algorithm or a similar algorithm is applied to find the shortest path. Dijkstra's algorithm is well-known in the computer science field and creates a tree of paths by calculating the shortest path from one node to every other node. This action is performed at the beginning to plan routes.

Next, the action function is represented by a(s)=s^{t}; s, s^{t}∈S.

Where S is the set of all possible states. The reward function is represented by r (s, a)=r_{s,a}; r_{s,a}∈R.

The reward function is further crafted as follows. At every step of the Markovian decision problem, the agent decides to take action a. This action represents a destination with the knowledge that the AV/pod is standing at pick-up stop i and has requests vector representation \vec{θ} with the time limit per request, Tₘₐₓ which is the maximum amount of time a passenger is willing to wait.

The list of requests is updated at each time step to eliminate requests that have exceeded the maximum wait time, with t_{req} being the time the AV took to serve a request. It is possible that an outdated request pends for some small amount of time if the AV is deployed before Tₘₐₓ arrives. Then, the request reward function n for a single AV/pod i is −1 if (=0, 0 if the vehicle is driving, 0 if θ₁=1 and t_{req}≥Tₘₐₓ and a suitable reward function of Nₚ, Tₘₐₓ and t_{req} if θ₁=1 and f_{req}<Tₘₐₓ.

Each reward function only rewards vehicles when they complete the request before the set maximum amount of time. If the vehicle arrives at a destination with no requests, there is a negative reward as this indicates the vehicle has wasted time driving to a place with no requests. While vehicle is driving, it cannot accumulate new rewards. Furthermore, higher rewards go to requests completed earlier and with more passengers picked up. The total reward is the average of the reward collected by every vehicle or,

$${r}_{tot} = \sum \frac{{r}_{i}}{m} .$$

Higher rewards can also be set for AVs that more frequently form AV trains and/or for large AV trains that improve overall system efficiency. Coupling the Markovian decision problem with the reward and action function, the dispatch problem can be represented as an RL problem. The applied formulation is a Q-learning algorithm. Q-learning can be applied to a Markovian decision problem. Q-learning finds an optimal policy for the taxi dispatcher according to the specified reward function. Consider a standard Q-learning algorithm with variables reward discount g, learning rate a and exploration rate ε. The Q-learning update rule is Q(s, a)=(1−α)Q(s, a)+α[rₜₒₜ+γE_{π}(maxQ*(s⁰, a⁰))]. The corresponding algorithm is shown in Algorithm 1 below.

Algorithm 1 Q Learning Algorithm

| | |
|---|---|
| 1: | Initialize Q-table of size (states, actions) |
| 2: | Choose reward discount, learning rate and exploration rate |
| 3: | Do |
| 4: | Choose random number between 0 and 1 |
| 5: | If random number is less than exploration rate |
| 6: | Choose random action |
| 7: | Else |
| 8: | Choose maximum Q-action |
| 9: | Perform chosen action |
| 10: | Observe |
| 11: | Update Q entry based on previously defined Q-update |
| 12: | Until |
| 13: | Reward threshold is achieved |

γ>0 is the reward discount and represents how much weight current rewards have vs. past rewards. γ is set to a lower value for the beginning iterations since the algorithm will count the immediate rewards much heavily than long-term rewards. Once training reaches above a certain number of episodes, it slowly increases γ until it is a value close to 1. α>0 is the learning rate and represents how fast the new Q-value observed is adopted. α is slowly decreased over time from a large value close to 1 to a small value. ε>0 chooses the odds in which a random action is chosen, i.e., the exploration vs. exploitation rate.

An example AV (101) can use the above and similar techniques and methods for being dispatched based on demand and navigate its environment. Additionally, and/or alternatively, a computing device (103) can similarly use such techniques and methods to coordinate operations (e.g., docking and undocking to form or disband AV trains, pickups, dropoff, and so on) within a network.

### Example Computing Device

FIG. 4 shows an exemplary computing device in accordance with certain implementations described herein. The computing device is only one example and is not intended to suggest any limitation as to the scope of use or functionality.

Numerous other general purpose or special purpose computing devices environments or configurations may be used. Examples of computing devices, environments, and/or configurations that may be suitable for use include, but are not limited to, personal computers, server computers, handheld or laptop devices, multiprocessor systems, microprocessor-based systems, network personal computers (PCs), minicomputers, mainframe computers, embedded systems, distributed computing environments that include any of the above systems or devices, and the like.

Computer-executable instructions, such as program modules, being executed by a computer may be used. Generally, program modules include routines, programs, objects, components, data structures, etc. that perform particular tasks or implement particular abstract data types. Distributed computing environments may be used where tasks are performed by remote processing devices that are linked through a communications network or other data transmission medium. In a distributed computing environment, program modules and other data may be located in both local and remote computer storage media including memory storage devices.

With reference to FIG. 4, an exemplary system for implementing aspects described herein includes a computing device, such as computing device 400. In its most basic configuration, computing device 400 typically includes at least one processing unit 402 and memory 404. Depending on the exact configuration and type of computing device, memory 404 may be volatile (such as random-access memory (RAM)), non-volatile (such as read-only memory (ROM), flash memory, etc.), or some combination of the two. This most basic configuration is illustrated in FIG. 4 by dashed line 406.

Computing device 400 may have additional features/functionality. For example, computing device 400 may include additional storage (removable and/or non-removable) including, but not limited to, magnetic or optical disks or tape. Such additional storage is illustrated in FIG. 4 by removable storage 408 and non-removable storage 410.

Computing device 400 typically includes a variety of computer readable media. Computer readable media can be any available media that can be accessed by the device 400 and includes both volatile and non-volatile media, removable and non-removable media.

Computer storage media include volatile and non-volatile, and removable and non-removable media implemented in any method or technology for storage of information such as computer readable instructions, data structures, program modules or other data. Memory 404, removable storage 408, and non-removable storage 410 are all examples of computer storage media. Computer storage media include, but are not limited to, RAM, ROM, electrically erasable program read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by computing device 400. Any such computer storage media may be part of computing device 400.

Computing device 400 may contain communication connection(s) 412 that allow the device to communicate with other devices. Computing device 400 may also have input device(s) 414 such as a keyboard, mouse, pen, voice input device, touch input device, etc. Output device(s) 416 such as a display, speakers, printer, etc. may also be included. All these devices are well known in the art and need not be discussed at length here.

It should be understood that the various techniques described herein may be implemented in connection with hardware or software or, where appropriate, with a combination thereof. Thus, the methods and apparatuses of the presently disclosed subject matter, or certain aspects or portions thereof, may take the form of program code (i.e., instructions) embodied in tangible media, such as floppy diskettes, CD-ROMs, hard drives, or any other machine-readable storage medium where, when the program code is loaded into and executed by a machine, such as a computing device, the machine becomes an apparatus for practicing the presently disclosed subject matter. In the case of program code execution on programmable computers, the computing device generally includes a processor, a storage medium readable by the processor (including volatile and non-volatile memory and/or storage elements), at least one input device, and at least one output device. One or more programs may implement or utilize the processes described in connection with the presently disclosed subject matter, for example, through the use of an application programming interface (API), reusable controls, or the like. Such programs may be implemented in a high-level procedural or object-oriented programming language to communicate with a computer system. However, the program(s) can be implemented in assembly or machine language, if desired. In any case, the language may be a compiled or interpreted language, and it may be combined with hardware implementations.

While embodiments of the present disclosure have been described with respect to specific embodiments, many modifications, variations, alterations, substitutions, and equivalents will be apparent to those skilled in the art. The present disclosure is not to be limited in scope by the specific embodiments described herein. Indeed, various modifications of the present disclosure, in addition to those described herein, will be apparent to those of skill in the art from the foregoing description and accompanying drawings. Accordingly, the invention is to be considered limited only by the spirit and scope of the disclosure (and claims), including all modifications and equivalents.

Still other embodiments will become readily apparent to those skilled in this art from reading the above-recited detailed description and drawings of certain exemplary embodiments. It should be understood that numerous variations, modifications, and additional embodiments are possible, and accordingly, all such variations, modifications, and embodiments are to be regarded as being within the spirit and scope of this application. For example, regardless of the content of any portion (e.g., title, field, background, summary, abstract, drawing figure, etc.) of this application, unless clearly specified to the contrary, there is no requirement for the inclusion in any claim herein or of any application claiming priority hereto of any particular described or illustrated activity or element, any particular sequence of such activities, or any particular interrelationship of such elements. Moreover, any activity can be repeated, any activity can be performed by multiple entities, and/or any element can be duplicated. Further, any activity or element can be excluded, the sequence of activities can vary, and/or the interrelationship of elements can vary. Unless clearly specified to the contrary, there is no requirement for any particular described or illustrated activity or element, any particular sequence or such activities, any particular size, speed, material, dimension or frequency, or any particular interrelationship of such elements. Accordingly, the descriptions and drawings are to be regarded as illustrative in nature, and not as restrictive.

It should be appreciated that various sizes, dimensions, contours, rigidity, shapes, flexibility, and materials of any of the components or portions of components in the various embodiments discussed throughout may be varied and utilized as desired or required.

It should be appreciated that while some dimensions are provided on the aforementioned figures, the device may constitute various sizes, dimensions, contours, rigidity, shapes, flexibility, and materials as it pertains to the components or portions of components of the device, and therefore may be varied and utilized as desired or required.

Although example embodiments of the present disclosure are explained in detail herein, it is to be understood that other embodiments are contemplated. Accordingly, it is not intended that the present disclosure be limited in its scope to the details of construction and arrangement of components set forth in the following description or illustrated in the drawings. The present disclosure is capable of other embodiments and of being practiced or carried out in various ways.

In summary, while the present disclosure has been described with respect to specific embodiments, many modifications, variations, alterations, substitutions, and equivalents will be apparent to those skilled in the art. The present disclosure is not to be limited in scope by the specific embodiment described herein. Indeed, various modifications of the present disclosure, in addition to those described herein, will be apparent to those of skill in the art from the foregoing description and accompanying drawings. Accordingly, the invention is to be considered as limited only by the spirit and scope of the disclosure, including all modifications and equivalents.

Still other embodiments will become readily apparent to those skilled in this art from reading the above-recited detailed description and drawings of certain exemplary embodiments. It should be understood that numerous variations, modifications, and additional embodiments are possible, and accordingly, all such variations, modifications, and embodiments are to be regarded as being within the spirit and scope of this application. For example, regardless of the content of any portion (e.g., title, field, background, summary, abstract, drawing figure, etc.) of this application, unless clearly specified to the contrary, there is no requirement for the inclusion in any claim herein or of any application claiming priority hereto of any particular described or illustrated activity or element, any particular sequence of such activities, or any particular interrelationship of such elements. Moreover, any activity can be repeated, any activity can be performed by multiple entities, and/or any element can be duplicated. Further, any activity or element can be excluded, the sequence of activities can vary, and/or the interrelationship of elements can vary. Unless clearly specified to the contrary, there is no requirement for any particular described or illustrated activity or element, any particular sequence or such activities, any particular size, speed, material, dimension or frequency, or any particular interrelationship of such elements. Accordingly, the descriptions and drawings are to be regarded as illustrative in nature and not as restrictive. Moreover, when any number or range is described herein, unless clearly stated otherwise, that number or range is approximate. When any range is described herein, unless clearly stated otherwise, that range includes all values therein and all sub-ranges therein. Any information in any material (e.g., a United States/foreign patent, United States/foreign patent application, book, article, etc.) that has been incorporated by reference herein is only incorporated by reference to the extent that no conflict exists between such information and the other statements and drawings set forth herein. In the event of such conflict, including a conflict that would render invalid any claim herein or seeking priority hereto, then any such conflicting information in such incorporated by reference material is specifically not incorporated by reference herein.

It must also be noted that, as used in the specification and the appended claims, the singular forms “a,” “an” and “the” include plural referents unless the context clearly dictates otherwise. Ranges may be expressed herein as from “about” or “approximately” one particular value and/or to “about” or “approximately” another particular value. When such a range is expressed, other exemplary embodiments include from the one particular value and/or to the other particular value.

By “comprising” or “containing” or “including” is meant that at least the named compound, element, particle, or method step is present in the composition or article or method, but does not exclude the presence of other compounds, materials, particles, method steps, even if the other such compounds, material, particles, method steps have the same function as what is named.

In describing example embodiments, terminology will be resorted to for the sake of clarity. It is intended that each term contemplates its broadest meaning as understood by those skilled in the art and includes all technical equivalents that operate in a similar manner to accomplish a similar purpose. It is also to be understood that the mention of one or more steps of a method does not preclude the presence of additional method steps or intervening method steps between those steps expressly identified. Steps of a method may be performed in a different order than those described herein without departing from the scope of the disclosed technology. Similarly, it is also to be understood that the mention of one or more components in a device or system does not preclude the presence of additional components or intervening components between those components expressly identified.

Embodiments of the present disclosure are further described in Appendix A which is a document describing implementations of the systems and methods described herein.

Numerous characteristics and advantages provided by aspects of the present disclosure have been set forth in the foregoing description and are set forth in the attached Appendix A, together with details of structure and function. While the present disclosure is disclosed in several forms, it will be apparent to those skilled in the art that many modifications can be made therein without departing from the spirit and scope of the present disclosure and its equivalents. Therefore, other modifications or embodiments as may be suggested by the teachings herein are particularly reserved.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed:

1. An autonomous vehicle system comprising:
a plurality of autonomous vehicles (AVs) in electronic communication with one another, each AV comprising:
at least one sensing device;
at least one processor; and
a memory having instructions stored thereon, wherein the instructions when executed by the at least one processor, cause the at least one processor to:
obtain vehicle data and/or environmental data via the at least one sensing device;
determine one or more following or coupling parameters for forming a variable AV train;
electronically and/or mechanically connect and disconnect to at least another AV to form the variable AV train; and
continuously broadcast the obtained vehicle and/or environmental data to the at least another AV subsequent to forming the variable AV train.

2. The autonomous vehicle system of claim 1, wherein each of the plurality of AVs is configured to obtain the vehicle data and/or environmental data or form the variable AV train in response to a request or command received from a computing device or at least one mobile device.

3. The autonomous vehicle system of claim 1, wherein the instructions when executed by each processor cause each processor to further:
self-navigate using the one or more following parameters and/or the broadcast and/or received data.

4. The autonomous vehicle system of claim 1, wherein operations of each AV are optimized using one or more algorithms or machine learning models.

5. The autonomous vehicle system of claim 1, wherein each processor is further configured to dynamically switch between obtaining data from the at least one sensing device to at least one mobile device within the AV based on detected environmental conditions.

6. The autonomous vehicle system of claim 5, wherein the environmental conditions include at least one of poor visibility, sensor malfunction, and low battery.

7. The autonomous vehicle system of claim 1, wherein each processor is configured to continuously broadcast the obtained vehicle and/or environmental data using a Bluetooth BLE advertising mode, short-range wireless communication protocol, or Near-Field Communication (NFC) protocol.

8. The autonomous vehicle system of claim 1, wherein the vehicle data and/or environmental data includes at least one of speed, location, acceleration, relative distance, or relative speed.

9. The autonomous vehicle system of claim 1, wherein each AV is configured to self-navigate using a reinforcement learning model or optimization operation.

10. The autonomous vehicle system of claim 1, wherein each AV comprises a drive-by-wire component.

11. An autonomous vehicle (AV) comprising:
at least one sensing device;
at least one processor (e.g., cloud-based processing system) in electronic communication with the at least one vehicle; and
a memory having instructions thereon, wherein the instructions when executed by the processor, cause the processor to:
obtain vehicle data and/or environmental data via the at least one sensing device;
determine one or more following or coupling parameters for forming a variable AV train;
electronically and/or mechanically connect and disconnect to at least another AV to form the variable AV train; and
continuously broadcast the obtained vehicle and/or environmental data to the at least another AV subsequent to forming the variable AV train.

12. The AV of claim 11, wherein the AV is configured to obtain the vehicle data and/or environmental data or form the variable AV train in response to a request or command received from a computing device or at least one mobile device.

13. The AV of claim 11, wherein the instructions when executed by the processor causes the processor to further:
self-navigate using the one or more following parameters and/or the broadcast and/or received data.

14. The AV of claim 11, wherein operations of the AV are optimized using one or more algorithms or machine learning models.

15. The AV of claim 11, wherein the processor is further configured to dynamically switch between obtaining data from the at least one sensing device to at least one mobile device within the AV based on detected environmental conditions.

16. The AV of claim 15, wherein the environmental conditions include at least one of poor visibility, sensor malfunction, and low battery.

17. The AV of claim 11, wherein the processor is configured to continuously broadcast the obtained vehicle and/or environmental data using a Bluetooth BLE advertising mode, short-range wireless communication protocol, or Near-Field Communication (NFC) protocol.

18. The AV of claim 11, wherein the vehicle data and/or environmental data includes at least one of speed, location, acceleration, relative distance, or relative speed.

19. A computer-implemented method comprising:
receiving, by at least one processor, at least one ride hailing request;
determining, by the at least one processor, one or more optimal docking location(s) based at least in part on the at least one ride hailing request;
determining, by the at least one processor, at least one AV route to the one or more optimal docking location(s); and
triggering, by the at least one processor, docking operations, undocking operations, and/or navigation of at least one variable AV train based at least in part on the at least one AV route,
wherein the at least one variable AV train comprises a plurality of AVs that are each configured to:
determine one or more following or coupling parameters for forming the at least one variable AV train,
electronically and/or mechanically connect and disconnect to at least another AV to form the at least one variable AV train, and
continuously broadcast obtained vehicle and/or environmental data to at least another AV subsequent to forming the at least one variable AV train.

20. The computer-implemented method of claim 19, wherein each AV is configured to dynamically switch between obtaining data from at least one sensing device and at least one mobile device within the AV based on detected environmental conditions.
